(19) United States
(12) Patent Application Publication
(10) Pub. No.: US 2025/0307454 A1
(43) Pub. Date: Oct. 2, 2025

(54) SYSTEM AND METHODS FOR MANAGING ACCESS TO A PROTECTED DATA RESOURCE

(71) Applicant: The Toronto-Dominion Bank, Toronto (CA)

(72) Inventors: Samantha Marie Oliveira ESTOESTA, Kitchener (CA); Matthew VOLLICK, London (CA)

(73) Assignee: The Toronto-Dominion Bank, Toronto, ON (CA)

(21) Appl. No.: 18/618,774

(22) Filed: Mar. 27, 2024

(51) Int. Cl. G06F 21/62; G06Q 40/02; G06Q 40/08

(52) U.S. Cl. CPC G06F 21/6245; G06Q 40/02; G06Q 40/08

(57) ABSTRACT

A computer-implemented method is disclosed. The method includes: receiving, via a user interface on a first computing device at a first time, an access request for accessing a specified account; obtaining data capturing account activity of the specified account prior to the first time; determining a first status of a first requesting account associated with the access request based on the obtained data, the first status indicating a determined relationship between the specified account and the first requesting account; and configuring the user interface to selectively enable account features of the specified account based on the first status of the first requesting account.

### TECHNICAL FIELD

The present application relates to data security and, more particularly, to a system and methods for managing access to protected data resources.

### BACKGROUND

Support for individuals who require care can be logistically challenging. Improper handling of private information can deprive care recipients of agency. The process of providing, to a caregiver, access to their dependents' private and protected data, such as banking information, is often slow and fraught with legal obstacles. Existing tools for enabling care providers to manage their dependents' personal accounts are limited in functionality, require substantial input by the care recipients (who may be incapacitated or lack digital literacy), and provide little flexibility for setting individual user rights beyond manual assignment (e.g., assignment by a care recipient or administrator).

### BRIEF DESCRIPTION OF THE DRAWINGS

Reference will now be made, by way of example, to the accompanying drawings which show example embodiments of the present application and in which:

FIG. 1 is a schematic diagram illustrating an operating environment of an example embodiment;

FIG. 2A is a high-level schematic diagram of an example computing device;

FIG. 2B is a schematic block diagram showing a simplified organization of software components stored in memory of the example computing device of FIG. 2A;

FIG. 3 is a schematic diagram showing components of a backend system for providing a user interface in accordance with example embodiments of the present disclosure;

FIG. 4 shows, in flowchart form, an example method for managing access to a protected data resource; and

FIG. 5 shows, in flowchart form, another example method for managing access to a protected data resource.

Like reference numerals are used in the drawings to denote like elements and features.

### DETAILED DESCRIPTION OF EXAMPLE EMBODIMENTS

In an aspect, a computing system is disclosed. The computing system includes a processor and a memory coupled to the processor. The memory stores instructions that, when executed by the processor, may cause the processor to: receive, via a user interface on a first computing device at a first time, an access request for accessing a specified account; obtain data capturing account activity of the specified account prior to the first time; determine a first status of a first requesting account associated with the access request based on the obtained data, the first status indicating a determined relationship between the specified account and the first requesting account; and configure the user interface to selectively enable account features of the specified account based on the first status of the first requesting account.

In some implementations, the data capturing the account activity of the specified account may comprise at least one of: a list of one or more beneficiaries determined based on historical account records of savings plans associated with the specified account; a list of one or more beneficiaries of life insurance policies associated with the specified account; a list of one or more payees determined based on historical payments data of the specified account; address history identifying at least one shared address; a list of one or more joint account holders of the specified account; a set of one or more insurance documents associated with the specified account; a list of one or more co-signers of loans or mortgages associated with the specified account; travel patterns based on historical transactions data of the specified account.

In some implementations, the access request may comprise a request to log in to the specified account using the user interface.

In some implementations, the first status may include an indicator of probability of the determined relationship between the specified account and the first requesting account.

In some implementations, the instructions, when executed, may further configure the processor to generate recommendations of user rights for the first requesting account based on the first status.

In some implementations, the instructions, when executed, may further configure the processor to determine a mapping between relationship indicators and user rights in connection with the specified account, and the first status of the first requesting account may be determined based on the mapping.

In some implementations, the instructions, when executed, may further configure the processor to: detect a first account activity for the specified account that is associated with the first requesting account; determine an updated first status of the first requesting account based on the detected first account activity; and configure the user interface to selectively enable account features of the specified account in accordance with the updated first status of the first requesting account.

In some implementations, determining the updated first status of the first requesting account may include determining that a frequency of the first account activity exceeds a defined threshold value.

In some implementations, the first account activity may comprise a transfer of data from the specified account to a first account of the first requesting account.

In some implementations, configuring the user interface to selectively enable account features of the specified account may include: determining a set of permitted account features for the first requesting account; and enabling only those user interface elements associated with the permitted account features on the user interface.

In another aspect, a computer-implemented method is disclosed. The method may include: receiving, via a user interface on a first computing device at a first time, an access request for accessing a specified account; obtaining data capturing account activity of the specified account prior to the first time; determining a first status of a first requesting account associated with the access request based on the obtained data, the first status indicating a determined relationship between the specified account and the first requesting account; and configuring the user interface to selectively enable account features of the specified account based on the first status of the first requesting account.

In another aspect, a non-transitory computer readable storage medium is disclosed. The computer readable storage medium stores computer-executable instructions that, when executed by a processor, may cause the processor to: receive, via a user interface on a first computing device at a first time, an access request for accessing a specified account; obtain data capturing account activity of the specified account prior to the first time; determine a first status of a first requesting account associated with the access request based on the obtained data, the first status indicating a determined relationship between the specified account and the first requesting account; and configure the user interface to selectively enable account features of the specified account based on the first status of the first requesting account.

Other example embodiments of the present disclosure will be apparent to those of ordinary skill in the art from a review of the following detailed descriptions in conjunction with the drawings.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

Individuals in need of care, such as persons with chronic conditions or who require palliative care, can invite care providers to access their personal accounts, including account information and associated functions and set individual user rights for each verified care provider. Incapacitation or digital illiteracy may prevent care recipients from providing, to legitimate care providers, proper user rights for accessing their accounts. This may result in the care providers being denied access, or only granted limited access, to their dependents' accounts. Enabling the identification of potential trusted contacts, or a calculated probability of a potential relationship between a care recipient and a caregiver, is difficult to do across multiple platforms and a varying number of access and privacy controls. The task of analyzing various data points across multiple platforms is challenging and generally involves a central aggregation point which effectively flattens the access and privacy controls. A new means of analysis is needed that will maintain the access and privacy controls for each data point in its native format.

The present application discloses a dashboard tool for care providers. The dashboard tool is a simple, easy-to-read interface that can be used by care providers to access their dependents' protected data, such as bank account information. Various actions for monitoring and managing a dependent's protected account are available in the dashboard tool. Care providers can configure single transaction thresholds and monthly spend thresholds, and be notified when a threshold is reached or exceeded. Care recipients can invite people in their care network to access the care recipients' account using the dashboard, and can set and modify user permissions.

The dashboard tool leverages data from numerous data sources (for example, through open banking) for identifying and verifying legitimate care providers, assigning permissions to authorized care providers, and providing recommendations for Power of Attorney (POA) or “trusted contacts”. In accordance with example embodiments, a computing system determines relationships across individuals that are related to a care recipient. The nature of an individual's relationship with a care recipient is preliminarily determined based on, at least, data captured across various data sources relating to the care recipient's account activity, such as: list of beneficiaries from RSP, RDSP, RESP in historical account records; list of beneficiaries of life insurance policies; list of payees from e-transfer list; address history (shared addresses) and KYC information; joint account holders; insurance documents such as renter insurance, home insurance, car insurance; co-signers of loans and mortgages; travel patterns based on transaction history (soft signals); and location history from mobile applications.

A determined relationship may be associated with an indicator of probability of relationship between account owners. Each determined relationship may also be associated with a set of one or more permissions for accessing the care recipient's protected account data and functions. More particularly, a mapping between determined relationships and user rights (defining user permissions for specific functions, resources, etc.) for the care recipient's account may be defined and implemented by the dashboard tool.

User rights for care providers may evolve as more account activity is undertaken for the care recipient's account. As account activity increases, more data that is suggestive or confirmatory of relationships to the care recipient may be captured. The user rights may thus be updated in accordance with the captured account activity data. For example, a single e-transfer to a contact from the care recipient's account may not suggest any relationship; however, multiple or recurring e-transfers to the same contact with the same secret question may be suggestive of a trusted contact relationship with the care recipient.

The dashboard tool is configured to provide, to each verified care provider, access to account information and functions of the care recipient's account. In particular, the dashboard tool may selectively enable user interface (UI) features that may be accessed by a particular care provider, based on the care provider's current user rights. That is, each instance of the dashboard tool as it appears on a care provider's device may look different, and the enabled functions will depend on the particular care provider's relationship as determined by the system and corresponding user rights and permissions (e.g., view-only, initiate, modify or reject transactions, etc.). In some implementations, the selective enabling of UI elements may be executed by configuring account data, including user rights and permissions, of the care recipient's account.

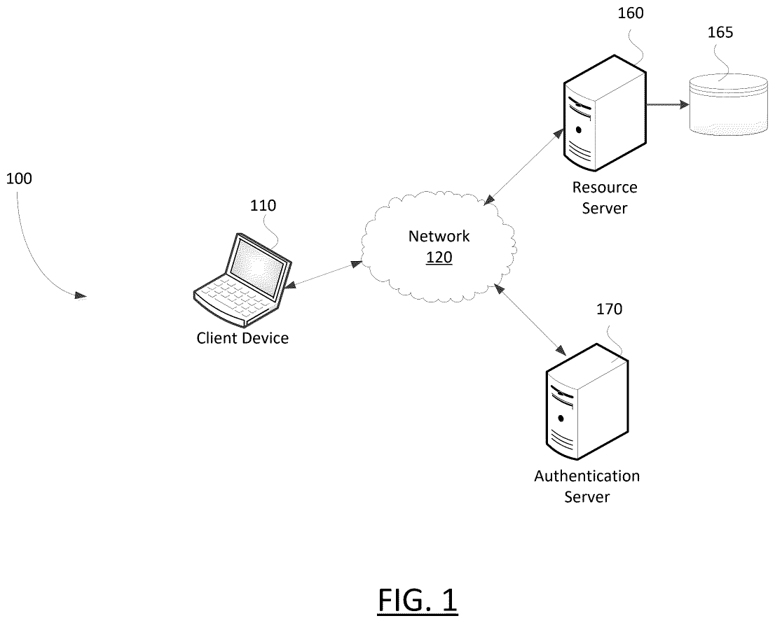

Reference is first made to FIG. 1 which illustrates an example networked environment 100 consistent with certain disclosed embodiments. As shown in FIG. 1, the networked environment 100 may include client devices 110, a resource server 160, a database 165 associated with the resource server 160, an authentication server 170, and a communications network 120 connecting various components of the networked environment 100.

The resource server 160 (which may also be referred to as a server computer system) and the client devices 110 communicate via the network 120. In at least some implementations, the client device 110 is a computing device. The client device 110 may take a variety of forms including, for example, a mobile communication device such as a smartphone, a tablet computer, a wearable computer such as a head-mounted display or smartwatch, a laptop or desktop computer, or a computing device of another type. The client device 110 is associated with a client entity (e.g., an individual, an organization, etc.) having resources which are managed by, or using, the resource server 160. For example, the resource server 160 may be a financial institution server and the client entity may be a customer of a financial institution that operates the financial institution server. The client device 110 may store software instructions that cause the client device to establish communications with the resource server 160.

The resource server 160 may be configured to track, manage, and maintain resources, make lending decisions, and/or lend resources to a client entity associated with the client device 110. The resources may, for example, comprise computing resources, such as memory or processor cycles. In at least some implementations, the resources may include stored value, such as fiat currency, which may be represented in a database. For example, the resource server 160 may be coupled to a database 165, which may be provided in secure storage. The secure storage may be provided internally within the resource server 160 or externally. The secure storage may, for example, be provided remotely from the resource server 160. For example, the secure storage may include one or more data centers storing data with bank-grade security.

The database 165 may include records for a plurality of accounts and at least some of the records may define a quantity of resources associated with the client entity. For example, the client entity may be associated with an account having one or more records in the database 165. The records may reflect a quantity of stored resources that are associated with the client entity. Such resources may include owned resources and, in some implementations, borrowed resources (e.g., resources available on credit). The quantity of resources that are available to or associated with the client entity may be reflected by a balance defined in an associated record such as, for example, a bank balance.

In some implementations, the database 165 may store various types of information relating to customers of a business entity that administers the resource server 160. For example, the database 165 may store customer profile data and financial account data associated with customers. The customer profile data may include, without limitation, personal information of registered customers, authentication credentials of the customers, account identifying information (e.g., checking and/or savings account numbers), and information identifying the services (e.g., banking services, investment management services, etc.) and programs that are offered to the customers by the business entity.

The client device 110 may be used, for example, to configure a data transfer from an account associated with the client device 110. More particularly, the client device 110 may be used to configure a data transfer from an account associated with an entity operating the client device 110. The data transfer may involve a transfer of data between a record in the database 165 associated with such an account and another record in the database 165 (or in another database such as a database associated with another server (not shown) which may be provided by another financial institution, for example, and which may be coupled to the resource server 160 via a network). The other record is associated with a data transfer recipient such as, for example, a bill payment recipient. The data involved in the transfer may, for example, be units of value and the records involved in the data transfer may be adjusted in related or corresponding manners. For example, during a data transfer, a record associated with the data transfer recipient may be adjusted to reflect an increase in value due to the transfer whereas the record associated with the entity initiating the data transfer may be adjusted to reflect a decrease in value which is at least as large as the increase in value applied to the record associated with the data transfer recipient.

The networked environment 100 also includes an authentication server 170. In at least some embodiments, the authentication server 170 may include at least one network server (i.e., an authentication server) that comprises one or more computers. The authentication server 170 is used for network access control. Specifically, the authentication server 170 provides a service of verifying credentials of entities (e.g., a person, computing device, etc.) that attempt to access certain applications, services, or otherwise protected resources. The authentication server 170 may be configured to handle authentication for a plurality of applications/services. In particular, the authentication server 170 may receive and process requests to authenticate users at one or more web services. When a client entity requests access to a resource (e.g., a web service), an authentication request in connection with the client's access may be transmitted to the authentication server 170. For example, a server hosting a web service may request the authentication server 170 to verify the requesting client's identity.

The authentication server 170 may implement one or more authentication protocols, depending on specific application and security requirements. Upon confirming the identity of a requesting client, the authentication server 170 may generate a response to the authentication request. The response may include, for example, an indication of an authentication status for a client. Generally, the authentication server 170 cooperates with at least one authorization server for providing appropriate permissions to an authenticated client. For example, when an end user of a web service is authenticated, the authentication server 170 may request an authorization server to release suitable access tokens to the authenticated user. In some embodiments, an authorization server may serve both authentication and authorization functions. That is, the authentication server 170 may comprise an authorization server.

While the authentication server 170 is illustrated in FIG. 1 as being external to the web server 150, it will be understood that the authentication server 170 may be integrated with the web server 150 in some embodiments. By way of example, the authentication server 170 may be implemented as a component, such as a software module (i.e., authentication module), of the resource server 160. More generally, the functions of the authentication server 170 may be provided as part of authentication services that are implemented by the resource server 160.

The client device 110, the resource server 160, and the authentication server 170, may be in geographically disparate locations. Put differently, the client device 110 may be remote from the resource server 160 and/or the authentication server 170. As described above, each of the client device 110, the resource server 160, and the authentication server 170 may be a computer system.

The network 120 is a computer network. In some implementations, the network 120 may be an internetwork such as may be formed of one or more interconnected computer networks. For example, the network 120 may be or include an Ethernet network, an asynchronous transfer mode network, a wireless network, or the like.

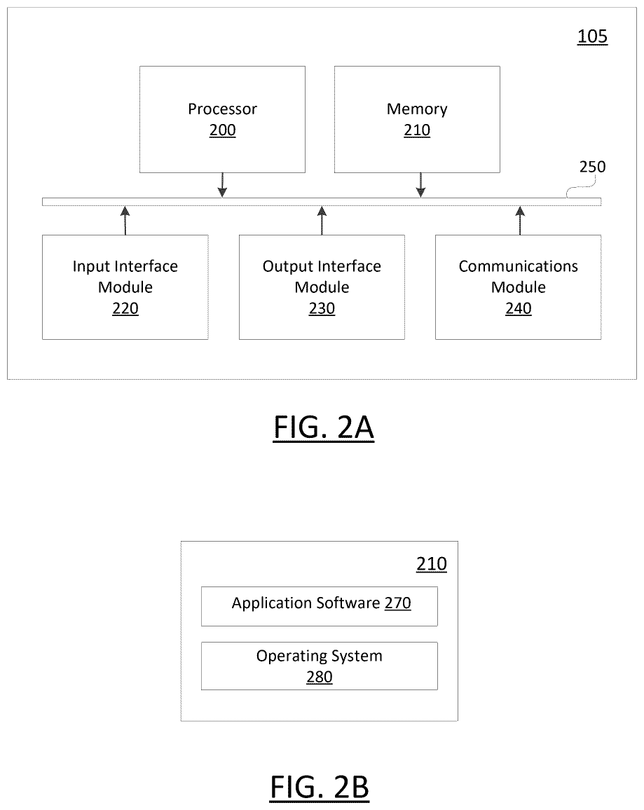

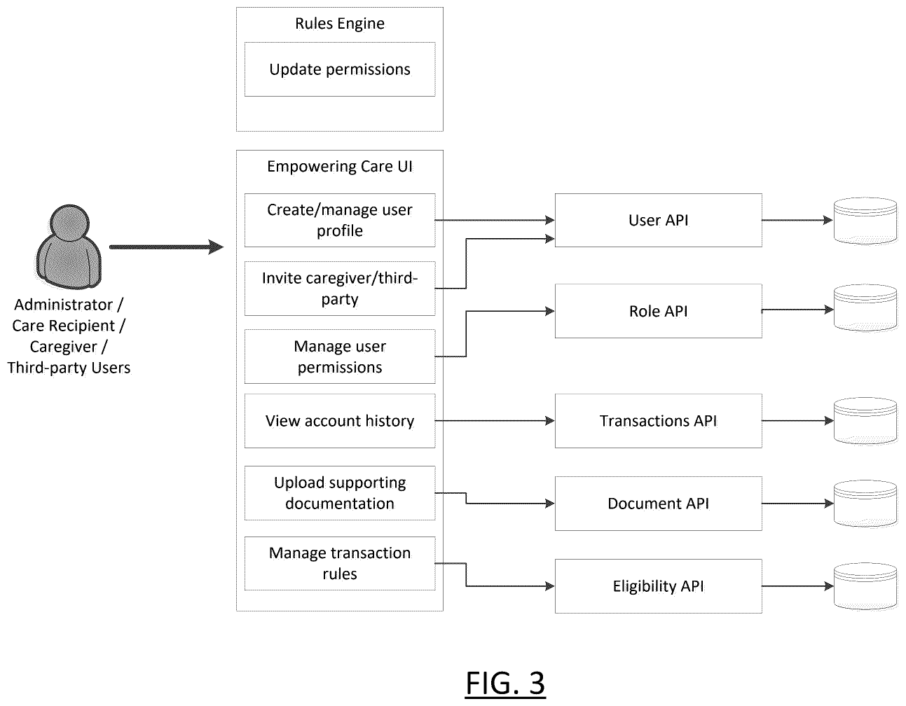

FIG. 2A is a high-level operation diagram of an example computing device 105. In some implementations, the example computing device 105 may be exemplary of one or more of: the client device 110, the resource server 160, and the authentication server 170. The example computing device 105 includes a variety of modules. For example, as illustrated, the example computing device 105, may include a processor 200, a memory 210, an input interface module 220, an output interface module 230, and a communications module 240. As illustrated, the foregoing example modules of the example computing device 105 are in communication over a bus 250.

The processor 200 is a hardware processor. For example, the processor 200 may be one or more ARM, Intel x86, PowerPC processors or the like.

The memory 210 allows data to be stored and retrieved. The memory 210 may include, for example, random access memory, read-only memory, and persistent storage. Persistent storage may be, for example, flash memory, a solid-state drive or the like. Read-only memory and persistent storage are a computer-readable medium. A computer-readable medium may be organized using a file system such as may be administered by an operating system governing overall operation of the example computing device 105.

The input interface module 220 allows the example computing device 105 to receive input signals. Input signals may, for example, correspond to input received from a user. The input interface module 220 may serve to interconnect the example computing device 105 with one or more input devices. Input signals may be received from input devices by the input interface module 220. Input devices may, for example, include one or more of a touchscreen input, keyboard, trackball or the like. In some implementations, all or a portion of the input interface module 220 may be integrated with an input device. For example, the input interface module 220 may be integrated with one of the aforementioned examples of input devices.

The output interface module 230 allows the example computing device 105 to provide output signals. Some output signals may, for example allow provision of output to a user. The output interface module 230 may serve to interconnect the example computing device 105 with one or more output devices. Output signals may be sent to output devices by output interface module 230. Output devices may include, for example, a display screen such as, for example, a liquid crystal display (LCD), a touchscreen display. Additionally, or alternatively, output devices may include devices other than screens such as, for example, a speaker, indicator lamps (such as for, example, light-emitting diodes (LEDs)), and printers. In some implementations, all or a portion of the output interface module 230 may be integrated with an output device. For example, the output interface module 230 may be integrated with one of the aforementioned example output devices.

The communications module 240 allows the example computing device 105 to communicate with other electronic devices and/or various communications networks. For example, the communications module 240 may allow the example computing device 105 to send or receive communications signals. Communications signals may be sent or received according to one or more protocols or according to one or more standards.

For example, the communications module 240 may allow the example computing device 105 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally, or alternatively, the communications module 240 may allow the example computing device 105 to communicate using near-field communication (NFC), via Wi-Fi™, using Bluetooth™ or via some combination of one or more networks or protocols. Contactless payments may be made using NFC. In some implementations, all or a portion of the communications module 240 may be integrated into a component of the example computing device 105. For example, the communications module may be integrated into a communications chipset.

Software comprising instructions is executed by the processor 200 from a computer-readable medium. For example, software may be loaded into random-access memory from persistent storage of memory 210. Additionally, or alternatively, instructions may be executed by the processor 200 directly from read-only memory of memory 210.

FIG. 2B depicts a simplified organization of software components stored in memory 210 of the example computing device 105. As illustrated these software components include an operating system 280 and application software 270.

The operating system 280 is software. The operating system 280 allows the application software 270 to access the processor 200, the memory 210, the input interface module 220, the output interface module 230, and the communications module 240. The operating system 280 may be, for example, Apple IOS™, Google's Android™, Linux™, Microsoft Windows™, or the like.

The application software 270 adapts the example computing device 105, in combination with the operating system 280, to operate as a device performing particular functions. The application software 270 may, for example, comprise a resource allocation application. A resource allocation application may be used to define operations, tasks, or objectives associated with the client device 110 or a user of the client device 110, and to allocate various quantities of resources to the defined operations/tasks/objectives. The resource allocation application may be a personal finance management (PFM) application. A PFM application allows users to track expenses, balances, and savings, and facilitates personal budgeting.

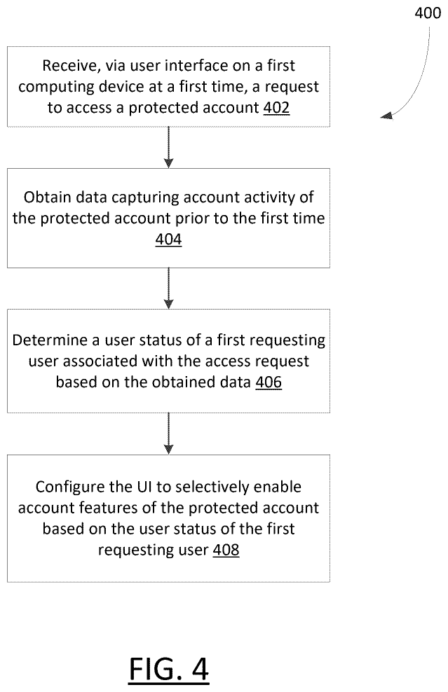

Reference is made to FIG. 4 which shows, in flowchart form, an example method 400 of managing user access to a protected data resource. In at least some implementations, the method 400 may be implemented as part of a process for providing a user interface for accessing account features of a protected user account. The operations of method 400 may be performed by a computer system, such as the authentication server 170 of FIG. 1, that is configured to coordinate with a resource server for controlling access to data records associated with the resource server.

In operation 402, the computing system receives, via a user interface on a first computing device at a first time, an access request for accessing a user account. The access request may, for example, be a request to log in to the user account using the user interface. The user account is a protected account of an account owner and the access request may originate from a caregiver (or similar relationship) for the account owner.

In operation 404, the computing system obtains data capturing account activity of the user account prior to the first time. The account activity data may be stored in memory associated with a protected resource server that manages data records of a plurality of user accounts. The account activity comprises all or a subset of all past activities conducted by the account owner in connection with the user account. In some implementations, the account activity may be captured by the products and services that are that are connected to the user account. For example, the account activity data may include a list of beneficiaries based on historical account records of savings plans (e.g., Registered Retirement Savings Plan, Registered Disability Savings Plan, Registered Education Savings Plan, etc.) associated with the user account, a list of beneficiaries of life insurance policies associated with the user account, a list of co-signers of loans or mortgages associated with the user account, a set of insurance documents associated with the user account, and the like.

In some implementations, the account activity may be captured by user profile history and transactions that are conducted in connection with the user account. For example, the account activity data may include a list of payees determined based on historical payments data of the user account, address history identifying at least one shared address, a list of joint account holders of the user account, travel patterns based on historical transactions data of the user account, location history determined based on app usage, and the like.

In operation 406, the computing system determines a first status of a first requesting account associated with the access request based on the obtained data. The first requesting account is a user account of a first (access)-requesting entity/user. The first status indicates a determined relationship between the user account and the first requesting account. In particular, the computing system is configured to infer a relationship between the account owner of the user account and the first requesting user. The computing system may determine whether the first requesting user is a “trusted contact” of the account owner that can gain access to the user account. The first status as a trusted contact enables a requesting user to receive various permissions in connection with the user account. The set of permissions for a trusted contact depends on granular details of the relationship to the account owner.

In some implementations, the first status may include an indicator of probability of the determined relationship between the account owner and the first requesting user. The probability reflects the likelihood that an inference of the relationship is correct. The probability may be indicated as a numerical value or as falling within a particular range of likelihood. For example, the likelihood of a correct inference for a requesting user may be mapped or assigned to one of a plurality of distinct ranges of likelihoods. The ranges may correspond to different levels of trust and/or permissions which can be attributed to the requesting user.

More generally, the assigned trust levels for contacts that are granted access to the user account may be categorized based on whether the relationship of the contact to the account owner is inferred or expressly specified by the account owner. For example, the trust levels and associated permissions for the user account may comprise two levels, or tiers, of trust-a first level for those individuals that are expressly identified by the account owner as their trusted contacts, and a second level for those individuals that are inferred to be trusted contacts based on account activity data of the user account.

In some implementations, once the computing system determines a relationship (inferred or explicit) between the first requesting user and the account owner, the computing system may be configured to prompt the requesting user and/or the account owner to provide confirmation of the determined relationship. Additionally, the computing system may generate recommendations of user rights for the first requesting user based on the first status. The computing system may further determine a mapping between relationship indicators and user rights in connection with the user account, and the first status of the first requesting user may be determined based on the mapping. In some implementations, the computing system may provide suggestions of inferred relationship to the account owner, such that the account owner may explicitly select from one of the suggested relationships for the first requesting user. Additionally, or alternatively, the computing system may provide, to the account owner, recommendations of actions (e.g., opening a joint account, generating a Power of Attorney, etc.) which may be suitable to perform in connection with the first requesting user.

In operation 408, the computing system configures the user interface to selectively enable account features of the user account based on the first status of the first requesting user. The user interface may, for example, be a graphical user interface of an application (e.g., a personal finance management app) that is used to manage and access features of the user account. In at least some implementations, the computing system determines a set of permitted account features for the first requesting user. The computing system enables only those user interface elements that are associated with the permitted account features on the user interface. For example, the UI elements corresponding to the enabled features are displayed and selectable, while the non-enabled features may not be displayed or grayed-out (or otherwise rendered non-selectable) on the user interface.

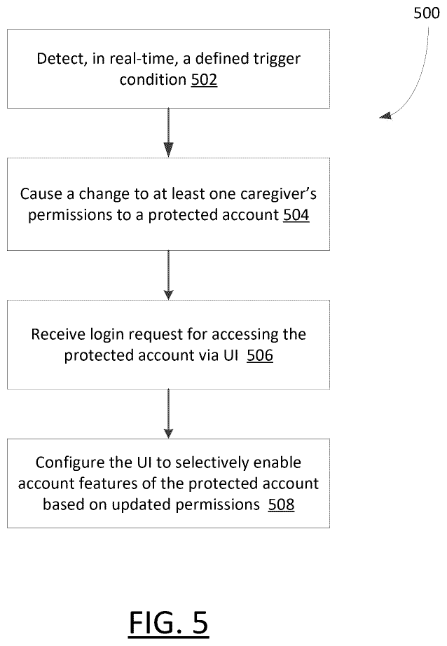

Reference is made to FIG. 5 which shows, in flowchart form, another example method 500 of managing user access to a protected data resource. In at least some implementations, the method 500 may be implemented as part of a process for providing a user interface for accessing account features of a protected user account. The operations of method 500 may be performed by a computer system, such as the authentication server 170 of FIG. 1, that is configured to coordinate with a resource server for controlling access to data records associated with the resource server.

In operation 502, the computing system detects, in real-time, a defined trigger condition. In some implementations, the trigger condition may comprise an account activity of a first type. More particularly, the computing system may detect a first account activity for the user account that is associated with a first user requesting access to the user account. For example, the first account activity may be a resource transfer to or from the user account (e.g., money transfer, deposit, etc.) by the requesting user. The transfer from be one that originates from the user account to a first account of the first requesting user. The trigger condition may be determined to be satisfied if, for example, a frequency of the first account activity exceeds a defined threshold value. As another example, the first account activity may be connecting of a new product or service to the user account that designates the requesting user as a related contact (e.g., beneficiary, co-signer, etc.).

Responsive to detecting the defined trigger condition, the computing system may determine an updated first status of the first requesting user. In operation 504, the computing system causes a change to at least one caregiver's permissions to a protected account. The updated first status of the first requesting user is determined based on the detected first account activity of the user account. For example, the first requesting user may be assigned to a higher trust level in connection with the user account as a result of the first account activity.

In operation 508, the computing system receives a login request for accessing the protected account via the user interface. The login request is received via a computing device of the first requesting user. The computing system configures the user interface to selectively enable account features of the protected account based on updated permissions for the first requesting user, in operation 510. In particular, the set of UI elements which are enabled for the account session for the first requesting user may be different from those which were previously enabled prior to the update to the user permissions for the first requesting user.

The various embodiments presented above are merely examples and are in no way meant to limit the scope of this application. Variations of the innovations described herein will be apparent to persons of ordinary skill in the art, such variations being within the intended scope of the present application. In particular, features from one or more of the above-described example embodiments may be selected to create alternative example embodiments including a sub-combination of features which may not be explicitly described above.

In addition, features from one or more of the above-described example embodiments may be selected and combined to create alternative example embodiments including a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

1. A computing system, comprising:
a processor, and
a memory coupled to the processor, the memory storing computer-executable instructions that, when executed by the processor, configure the processor to:
receive, via a user interface on a first computing device at a first time, an access request for accessing a specified account;
obtain data capturing account activity of the specified account prior to the first time;
determine a first status of a first requesting account associated with the access request based on the obtained data, the first status indicating a determined relationship between the specified account and the first requesting account; and
configure the user interface to selectively enable account features of the specified account based on the first status of the first requesting account.

2. The computing system of claim 1, wherein the data capturing the account activity of the specified account comprises at least one of:
a list of one or more beneficiaries determined based on historical account records of savings plans associated with the specified account;
a list of one or more beneficiaries of life insurance policies associated with the specified account;
a list of one or more payees determined based on historical payments data of the specified account;
address history identifying at least one shared address;
a list of one or more joint account holders of the specified account;
a set of one or more insurance documents associated with the specified account;
a list of one or more co-signers of loans or mortgages associated with the specified account;
travel patterns based on historical transactions data of the specified account.

3. The computing system of claim 1, wherein the access request comprises a request to log in to the specified account using the user interface.

4. The computing system of claim 1, wherein the first status includes an indicator of probability of the determined relationship between specified account and the first requesting account.

5. The computing system of claim 1, wherein the instructions, when executed, further configure the processor to generate recommendations of user rights for the first requesting account based on the first status.

6. The computing system of claim 1, wherein the instructions, when executed, further configure the processor to determine a mapping between relationship indicators and user rights in connection with the specified account, wherein the first status of the first requesting account is determined based on the mapping.

7. The computing system of claim 1, wherein the instructions, when executed, further configure the processor to:
detect a first account activity for the specified account that is associated with the first requesting account;
determine an updated first status of the first requesting account based on the detected first account activity; and
configure the user interface to selectively enable account features of the specified account in accordance with the updated first status of the first requesting account.

8. The computing system of claim 7, wherein determining the updated first status of the first requesting account comprises determining that a frequency of the first account activity exceeds a defined threshold value.

9. The computing system of claim 7, wherein the first account activity comprises a transfer of data from the specified account to a first account of the first requesting account.

10. The computing system of claim 1, wherein configuring the user interface to selectively enable account features of the specified account comprises:
determining a set of permitted account features for the first requesting account; and
enabling only those user interface elements associated with the permitted account features on the user interface.

11. A computer-implemented method, comprising:
receiving, via a user interface on a first computing device at a first time, an access request for accessing a specified account;
obtaining data capturing account activity of the specified account prior to the first time;
determining a first status of a first requesting account associated with the access request based on the obtained data, the first status indicating a determined relationship between the specified account and the first requesting account; and
configuring the user interface to selectively enable account features of the specified account based on the first status of the first requesting account.

12. The method of claim 11, wherein the data capturing the account activity of the specified account comprises one or more of:
a list of one or more beneficiaries determined based on historical account records of savings plans associated with the specified account;
a list of one or more beneficiaries of life insurance policies associated with the specified account;
a list of one or more payees determined based on historical payments data of the specified account;
address history identifying at least one shared address;
a list of one or more joint account holders of the specified account;
a set of one or more insurance documents associated with the specified account;
a list of one or more co-signers of loans or mortgages associated with the specified account;
travel patterns based on historical transactions data of the specified account.

13. The method of claim 11, wherein the access request comprises a request to log in to the specified account using the user interface.

14. The method of claim 11, wherein the first status includes an indicator of probability of the determined relationship between specified account and the first requesting account.

15. The method of claim 11, further comprising generating recommendations of user rights for the first requesting account based on the first status.

16. The method of claim 11, further comprising determining a mapping between relationship indicators and user rights in connection with the specified account, wherein the first status of the first requesting account is determined based on the mapping.

17. The method of claim 11, further comprising:
detecting a first account activity for the specified account that is associated with the first requesting account;
determining an updated first status of the first requesting account based on the detected first account activity; and
configuring the user interface to selectively enable account features of the specified account in accordance with the updated first status of the first requesting account.

18. The method of claim 11, wherein determining the updated first status of the first requesting account comprises determining that a frequency of the first account activity exceeds a defined threshold value.

19. The method of claim 11, wherein the first account activity comprises a transfer of data from the specified account to a first account of the first requesting account.

20. The method of claim 11, wherein configuring the user interface to selectively enable account features of the specified account comprises:
determining a set of permitted account features for the first requesting account; and
enabling only those user interface elements associated with the permitted account features on the user interface.
